(19) United States
(12) Patent Application Publication
(10) Pub. No.: US 2007/0046694 A1
(43) Pub. Date: Mar. 1, 2007

(54) System and method for image customization

(76) Inventors: Tamar Aizikowitz, Haifa (IL); Israel Roth, Ra'anana (IL); Reuven Sherwin, Ra'anana (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/500,941

(22) Filed: Aug. 9, 2006

Related U.S. Application Data
(60) Provisional application No. 60/710,610, filed on Aug. 24, 2005.

(51) Int. Cl. G09G 5/00

(52) U.S. Cl. 345/619

(57) ABSTRACT

Embodiments of the present invention may provide methods, devices and systems for receiving a plurality of input records and for each of the plurality of input records, replacing a placeholder layer in a multilayered image template file with a customized image layer created based on data in the input record.

### RELATED APPLICATION DATA

The present application claims benefit from prior U.S. provisional application Ser. No. 60/710,610, filed on Aug. 24, 2005, entitled “System and Method for Image Fusion”, the entire contents of which are incorporated herein by reference.

### FIELD OF THE INVENTION

Embodiments of the present invention relate generally to image processing, and to the automated individualization of image files based on individual record data in particular. The subject matter regarded as the invention is particularly pointed out and distinctly claimed in the concluding portion of the specification.

### BACKGROUND OF THE INVENTION

There exist various graphics software programs that enable users to manipulate visual images using a computing system. Manipulation options may for example include composing and combining multiple image layers, selecting one or more regions for editing, altering colors using various color models, e.g., RGB and HSV, and inserting text of various fonts and sized.

Graphics software programs may include raster graphics editors, which allow the user to work in bitmap formats such as JPEG, PNG, GIF, TIFF, and vector graphics editors, which allow the user to work in vector formats such as EPS, PDF, WMF, or SVG. Popular graphics software programs include Adobe Acrobat, Adobe Photoshop, Adobe Illustrator, GIMP and the like.

Image processing software products, such as those mentioned above, support the formation of an image from various objects, e.g., graphic frames, text frames, characters, etc., which, when put together, create the final image that one views on a display, for example, a single-layer image or a hard-copy print. These objects may relate to each other both in terms of their relative position in the X-Y coordinates of the resulting final image, as well as, possibly, relative positions in terms of a Z axis, which models a set of layers, from bottom to top. Thus, an object at a top layer may in fact hide parts of an object in a bottom layer, or show pails of such bottom object in case they have some transparency relationship defined for them.

Such image processing software products may be able to modify objects, replace objects, and handle the fusion of objects, possibly also via various layers, into one final image file. Another pertinent capability of such graphic software products may be their use of plug-in technologies and/or scripts or actions to extend their functionality and allow driving their being driven by them by or from other programs.

### SUMMARY OF EMBODIMENTS OF THE INVENTION

Embodiments of the present invention may provide methods, devices and systems for executing a set of commands to create a plurality of image files, where each image file may be a customized version of an original image based on user input data and/or logic. In some embodiments, a graphics software module may accept a user input information set. The set may include a plurality of information records, each of which may contain one or more data fields The graphics software module may integrate data taken or derived from an information set into a template layer to create one or more customizable image layers within the multilayer image. The customized image layers, for example, each when taken together with standard image layers, may produce a plurality of customized multilayer images. Thus, the graphics software module can create or be used to create a plurality of customized image files, which may then be produced to any output, for example, to print, save, email, etc. and, as needed, integrated into a series of documents, for example, one for each customized version.

In one embodiment, the multilayered default image file may include one or more placeholder layers. In such embodiments, the customized image layers may be inserted into the multilayered default image file by replacing the place holder layers. The template layer and/or the multilayered default image file may be designed or selected by a user according to the capabilities of the graphics software module. In one embodiment, the multilayered default image file may include one or more text layers containing place holders within the text. The textual place holders can be replaced by customized text content based on data in the information set and logic, thus creating a plurality of customized multilayer image files each containing customized text. In one embodiment, the multilayered default image file may include one or more layers having references to external image files, where these references can be replaced by data in the information set and logic, thus creating a plurality of customized multilayer image files each composed of different external image files

### BRIEF DESCRIPTION OF THE DRAWINGS

The invention, both as to organization and method of operation, together with objects, features and advantages thereof, may best be understood by reference to the following detailed description of embodiments of the invention when read with the accompanied drawings in which:

FIG. 1 is a schematic illustration of a computing system including graphics software capable of receiving user input and creating customized image files, according to embodiments of the present invention;

FIG. 2 is a schematic illustration of a graphical user interface for receiving user input information, according to one embodiment of the present invention;

FIG. 3 is a schematic illustration of data from each of a plurality of distinct information records being integrated into a template layer to generate a plurality of distinct customized image layers, according to one embodiment of the present invention;

FIG. 4 is a schematic illustration of the insertion of each of a plurality of customized image layers into a default image file to create a plurality of distinctly created customized image files, according to one embodiment of the present invention;

FIG. 5 is a flowchart of a method for fusing images, according to one embodiment of the present invention; and

FIG. 6 is a flowchart of a method for fusing images, according to one embodiment of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

The processes presented herein are not inherently related to any particular computer or other apparatus. Various general-purpose systems may be used with programs in accordance with the teachings herein, or it may prove convenient to construct a more specialized apparatus to perform embodiments of a method according to embodiments of the present invention. Embodiments of a structure for a variety of these systems appear from the description herein. In addition, embodiments of the present invention are not described with reference to any particular programming language It will be appreciated that a variety of programming languages may be used to implement the teachings of the invention as described herein.

Unless specifically stated otherwise, as apparent from the discussions herein, it is appreciated that throughout the specification discussions utilizing data processing or manipulation terms such as “processing”, “computing”, “calculating”, “determining”, or the like, typically refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

It will be appreciated that embodiments of the present invention may take various forms and may be integrated or cooperate with commercially available full-service graphic software programs Some applications embodying the present invention may be a stand-alone software program or application working in conjunction with a previously known or commercially available graphic software program, such as Adobe Photoshop. Other embodiments of the present invention may be a graphic software module intended as a plug-in to such a commercially available program. Yet other embodiments of the invention may be a module fully integrated into a commercially available full-service graphic software program, for example, as a feature of such a program. In the description below, reference is made to a graphic software module embodying the present invention; however, it will be understood that unless otherwise indicated, the invention is not limited in this respect, and may include all forms of integration with a full-service graphic software program that may execute some or all instructions of the module. Thus, while the description below may refer to the graphic software module executing certain commands, it will be understood that the module may do so by instructing another program, such as for example, Adobe Photoshop or another graphic program, to execute the commands.

One embodiment of the present invention includes a graphic software module that may execute a set of commands based on a user input set including a plurality of input information records to distinctly create a plurality of image files. In some embodiments, a multi-layer template image or file may be provided initially. In some embodiments, for each input information record in the user input information set, the graphic software module may generate at least one customized image layer. For each of the plurality of input records, the graphic software module may replace a placeholder layer in the multilayered image template with the customized image layer created based on data taken or derived from an input information record. Thus, the graphic software module may distinctly create a plurality of customized multilayered image files for a plurality of the records in the information set.

In an exemplary embodiment, the user input information may include personal customer information relating to a plurality of customers. The personalized image files may be created for printing, transfer, display, or other output, for example, on personalized gift items, such as business cards, greeting cards, clothing items, etc., according to known methods. Such embodiments may enable a user to automatedly generate a large number of customized or personalized image files, or other output based thereon.

Embodiments of the present invention may, for example, allow for a simple and/or easily navigated program, referred to as “customization application”, to automatedly, individually, and distinctly create customized image layers in multilayer images based on each of the user input records. The customization application may replace one or more place holder layers in a multilayered template image file with each of the customized image layers. Other or different benefits may result from embodiments of the present invention.

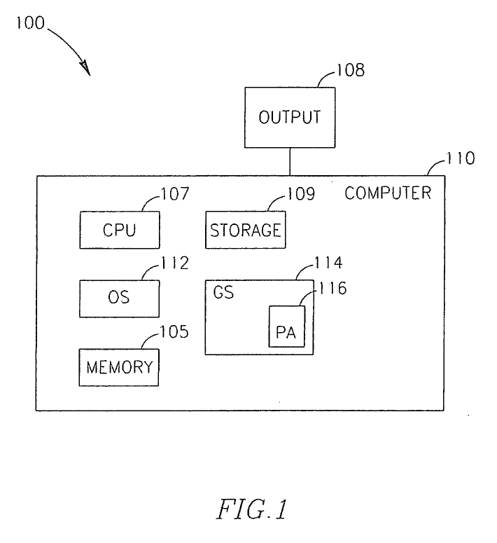

Reference is made to FIG. 1, which schematically illustrates a computing system including graphics software capable of receiving user input and creating customized image files, according to embodiments of the present invention. Computing system 100 may include local computer 110, which may include a memory 105, processor 107, monitor or output device 108, and mass storage device 109. Local computer 110 may include an operating system 112 and graphics software 114 including a customization application 116 capable of accepting user input and distinctly generating individually image files. In one embodiment, customization application 116 may be integrated into or part of graphics software 114. In another embodiment, customization application 116 may include software that is separate from graphics software 114. In such embodiments, graphics software 114 may interact with, and have access to, customization application 116, which may be for example, a “plug-in”. While customization application 116 code and/or software are depicted as being stored in graphics software 114, such code and/or software may be stored or reside elsewhere.

Computer 110 may include, e.g., a personal computer, a desktop computer, a mobile computer, a laptop computer, a notebook computer, a terminal, a workstation, a server computer, a personal digital assistant (PDA) device, a tablet computer, a network device, a micro-controller, a cellular phone, a camera, or any other suitable computing and/or communication device.

Output device 108 may include devices capable of executing output operations, for example, print, save, display, email, etc. for each of the customized image file. In some embodiments, the user may select one or more desired output operations.

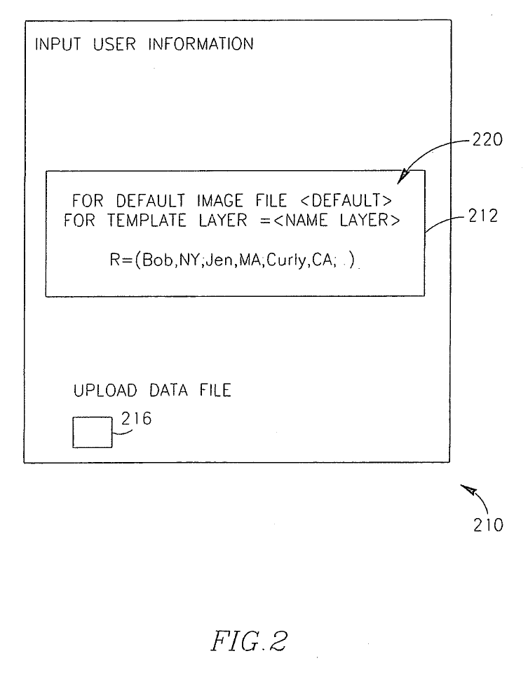

Reference is made to FIG. 2, which schematically illustrates a graphical user interface for receiving user input information, according to one embodiment of the present invention. User input information 220 may include, for example, data fields, coded text, data files and/or streaming data A user may, for example, enter user input information 220, for example, text, data files or code, into user information field 212 in graphical user interface 210. In some embodiments, a user may upload a data file that includes the user input information 220, for example, by selecting upload field 216 and/or by entering a name of the data file. In other embodiments, a user may provide input information 220 that may include streaming media, for example, accessed by a server via a network such as the Internet.

For example, user input information 220 may include (other sets of code, other algorithms, and other languages may be used):
For Default image file <Default>
For Template Layer 1=<Name Layer>
R=(Bob, NY; Jen, MA; Curly, CA; . . . )

In some embodiments, the user may wish to create a plurality of customized image files individually personalized for each customers based on the customers' personal information. In the example above, each customer's personal information record may include name and state data fields, for example, where records are separated by ‘;’ and fields are separated by ‘,’.

Users may enter user input information 220 that may include one or more categories of information, for example, names, state of residence, zip code of residence and/or workplace, demographics, age, income level and any other suitable information. User input information 220 may include, for example, names of customers, for example, Bob, Jen, Curly, etc., and/or states of residences, for example, New York, Massachusetts, California, etc., as depicted in FIG. 2, and/or data files, for example, including digital pictures of each customer or data links thereto, sound files, video files, etc. In one embodiment, each data file may be marked or tagged with information, for example, a customer name, identifying the customer depicted in an associated data file, so that the data file may be easily retrieved by graphic software module 114.

For each category of information, graphic software module 114 may receive user input information 220 from which it may receive or extract the plurality of distinct information records, <R>. For example, while other sets of code, other algorithms, and other languages may be used, graphic software module 114 may execute a command, for example:

Compute actual data for R, call it <R>

If R=(Name)=(Bob; Jen; Curly; . . . ), then set information records, <R>=<Bob>, <Jen>, <Curly>, . . .

In one embodiment, graphic software module 114 may receive user input information 220 corresponding to a plurality of categories of information, for example, R=(Name, State of Residence)=(Bob, NY; Jen, MA; Curly, CA; . . . ). For each of the plurality of categories of information, graphic software module 114 may define a distinct set of information records, for example, name information records <R₁> and state of residence information records <R₂>, where <R₁>=<Bob>, <Jen>, <Curly>, . . . and <R₁>=<NY>, <MA>, <CA>, . . . The distinct sets of information records may be computed by repeatedly executing the Compute actual data for Rᵢ, call it <Rᵢ> command for each category of information, where i varies.

In some embodiments, graphic software module 114 may use computing logic to extract, process or generate additional data from user input information 220. For example, based on a customer's state of residence, listed in state of residence information records <R₂>, graphic software module 114 may generate state flower information records <R₃>. For example, if <R₂>=<State of Residence>=<NY>, <MA>, <CA> . . . , graphic software module 114 may generate a new set of information records, <R₃>=<Rose>, <Mayflower>, <California Poppy>, . . .

In some embodiments, graphic software module 114 may modify or rewrite users' input information 220, for example, according to the conventions of supporting programs or systems. In various embodiments, graphic software module 114 may generate the information records, <R> automatically or at the user's request.

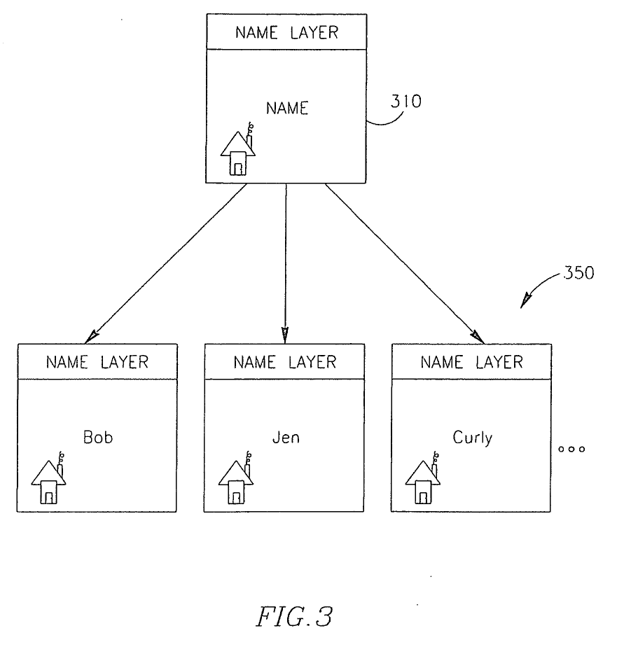

Reference is made to FIG. 3, which schematically illustrates data from each of a plurality of distinct information records being integrated into a template layer to generate a plurality of distinct customized image layers, according to one embodiment of the present invention. Users may select, customize or design one or more template layers 310 into which input information records, for example, individual customer information may be inserted. Template layers 310 may be designed according to the capabilities of, graphics software module 114 or if template layers 310 are selected or uploaded, the program(s) from which it was generated.

In some embodiments, graphic software module 114 may generate a distinct customized image layer 350 for each distinct information record, for example, by integrating or deriving data from each distinct information record into template layer 310. In one embodiment, graphic software module 114 may integrate data from each of the plurality of distinct information records into template layer 310, according to a series of commands. The commands may consist of a set of commands to be executed automatically as well as commands that may optionally be specified by the user, for example, by specifying these commands in the user information fields 212. While other sets of code, other algorithms, and other languages may be used, said command set may include, for example:

```
For each R
  Generate Instance:
    Compute actual data for R, call it <R>
    Invoke Init with <R>
    Invoke Pre with <R>
    Invoke Image Generation Module with <R>
    Invoke Post with <R>
    Invoke End with <R>
  End Generate Instance
END For
```

In some embodiment, Compute actual data for R, call it <R>, may define the plurality of user input information records, <R>, discussed above in reference to FIG. 2

For each of the plurality of distinct information records, Invoke Init with <R> may open a multilayer template file.

For each of the plurality of distinct information records, Invoke Pre with <R> may use computing logic to individually pre-process template layer 310 according to the individual information record, for example, in order to prepare template layer 310 for integrating the particular information record. Invoke Pre with <R> may execute processing operations on template layer 310 including, for example, graphic filters, copy-fitting features, standardization features to standardize formats, color schemes. etc. that may be desired to be performed on the multilayered template or on any layer thereof, prior to insertion of data pertaining to the particular record. In one embodiment, Invoke Pre with <R> may execute operations on template layer 310 individually based on the specific information record, <R>. For example, Invoke Pre with <R>, where R is a string of text units, may use computing logic to determine, based on the number of text units of R, the appropriate font size with which to integrate R into template layer 310 and may accordingly set the font size of template layer 310.

Image Generation (IG) Module may be any suitable graphic software capable of performing the required operations. For example, IG Module may typically be capable of modifying objects in the image representation, fusing all objects or layers together into a resulting image file.

For each of the plurality of distinct information records, Invoke Image Generation Module with <R> may customize the individual information record, for example, by integrating the individual information record, <R>, into the template layer 310, as processed by the Invoke Pre with <R> command. In some embodiments, Invoke Image Generation (IG) Module with <R> may customize the individual information record, for example, by modifying the individual information record so as to include <R>, into the template layer 310, as processed by the Invoke Pre with <R> command. For example, while other sets of code, other algorithms, and other languages may be used, using the example provided above, Invoke Image Generation Module with <R> may include commands such as:
For Template Layer Name Layer, replace any occurrence of the string “<Name>” with <R>, where R=(Bob).

It will be recognized that in embodiments of the present invention, IG Module may be integral with customization module, or it may be stand-alone from other modules. As discussed above, in some embodiments, the graphic software module may implement the operation of invoking IG module by calling on a commercially available graphic software program, such as, for example, Photoshop or Illustrator.

For each of the plurality of distinct information records, Invoke Post with <R> may use computing logic to individually process the template layer 310, for example, to finalize the customization of template layer 310. Invoke Post with <R> may execute processing operations on template layer 310, as processed by the Invoke Replace with <R> command, for example, integrated with data from the individual information record. Such operations may include, for example, graphic filters, copy-fitting features, standardization features to standardize formats, color schemes, etc. In one embodiment, Invoke Post with <R> may process template layer 310 individually based on the specific information record, <R>. For example, Invoke Post with <R>, where R includes a name and a gender, for example, R=(Bob, Male; Jen, Female; Curly, Male; . . . ), may set the color of the name blue for males and red for females In some embodiment the Invoke Pre and Invoke Post may include activation of a plug-in or additional automation scripts to further process the image. For example, a plug-in may be invoked to trace the outlines of the name to create a mosaic effect. In some embodiments Invoke Pre with <R> and/or Invoke Post with <R> may process template layer 310 according to the capabilities of graphics software module 114.

The processing sequence described above may repeat for each R to individually create a customized image layer 350 for each of the plurality of distinct information records, <R>.

In one embodiment, graphic software module 114 may receive user input information 220 defining a plurality of categories of information records, for example, <R₁> and <R₃>, where <R₁>=<Name>, . . . and <R₃>=<State Flower>, . . . , as described above in reference to FIG. 2. In one embodiment, for each distinct category of information records, the user may provide a distinct template layer 310 to separately integrate different categories of information records, according to embodiments of the invention. For each customer, one template layer 310 may integrate distinct information records <R₁> and another template layer 310 may integrate distinct information records <R₃>. Thus, for each customer, a separate customized image layer 350 may be created for each category of information. For example, for a customer, Bob, graphic software module 114 may create one customized image layer 350, displaying the name, “Bob”, and a separate customized image layer 350, displaying an image of Bob's state flower, a rose. In some embodiments, the user may title each template layer 310 with a unique title, for example, in order to differentiate each layer. For example, the user may title one of template layers 310, ‘Name Layer’, and another, ‘State Flower Layer’.

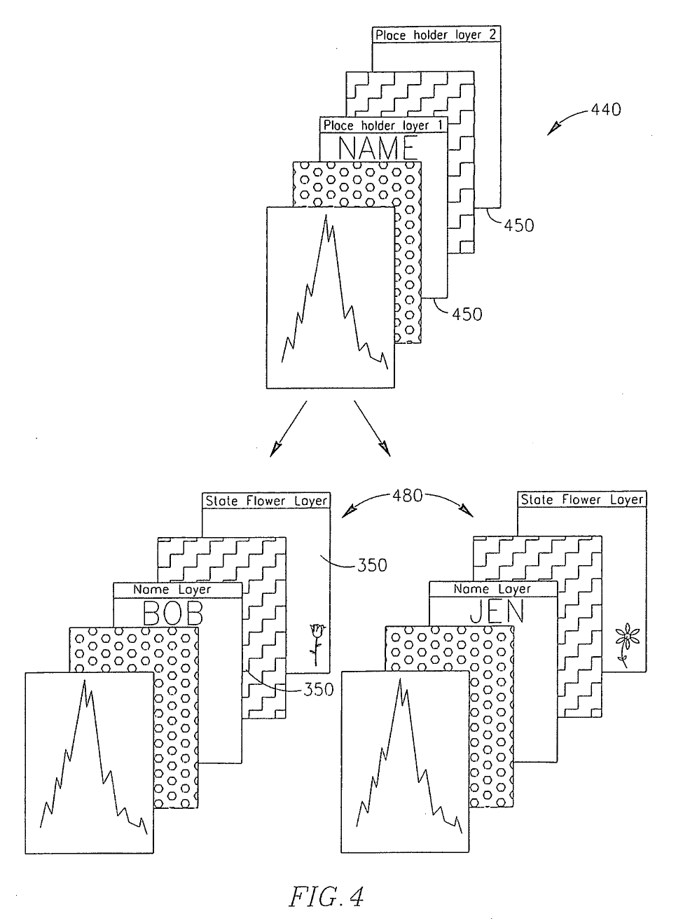

Reference is made to FIG. 4, which schematically illustrates the insertion of each of a plurality of customized image layers into a default image file to create a plurality of distinctly created customized image files, according to one embodiment of the present invention. The user may design or select a default image file 440 into which customized image layers 350, described above in reference to FIG. 3, may be fused or inserted to generate a plurality of distinct customized image files 480. In one embodiment, the user may design the default image file 440 according to the graphic design capabilities of graphics software module 114. In another embodiment, the user may select the default image file 440 from among one or more pre-designed image files that are, for example, stored in graphics software module 114, computer storage 109, or uploaded from an external source, for example, a remote sever or a website via the Internet.

A default image file or template 440 may be a multilayered file that includes one or more place holder layers 450. In one embodiment, place holder layers 450 may be blank or have default designs. Place holder layers 450 may be indexed, named or tagged, for example, ‘Layer 1’ and ‘Layer 2’, so that they may be easily retrieved or replaced. In one embodiment, for each customer, one or more customized image layer 350, each corresponding to a distinct category of information records, may be inserted into the same default image file 440. In some embodiments, a specific one of the customized image layers 350 may replace a specific one of place holder layers 450 in the default image file 440. For example, customized image layers 350, Name Layer and State Flower Layer, may replace place holder layers 450, Layer 1 and Layer 2, respectively. In one embodiment, there may be at least as many place holder layers 450 in default image file 440 as there are data fields in each information record, thereby enabling to independently and individually manipulate any of the placeholder layer. In one embodiment, there may be multiple place holder layers 450 in default image file 440 where more than one place holder layer corresponds to one data field in each information record, thereby enabling one data field to be used in customization of multiple place holder layers.

In embodiments where user input information 220 corresponds to a plurality of categories of information, for each customer, graphics software module 114 may replace each of the place holder layers 450 in default image file 440 with the customized image layer 350 corresponding to the customer's data for a distinct category of information. Thus, graphics software module 114 may individually create each of output image files 480, based on information records corresponding to each customer.

In some embodiments, multilayered output image files 480 may be converted into single layer image files, for example, by a known compression mechanism. Customized image files 480 may be delivered to an output device, for example, output device 108, described above in reference to FIG. 1, as multilayered or single layered image files. Output device 108 may execute an output mechanism, for example, print, save, display, email, etc. for each of the output image files 480.

In some embodiments, customized image files 480 may be generated in response to a user request for graphics software module 114 to output customized image files 480, for example, via output device 108. Thus, in this embodiment, system 100 need only stole user input information 220 and not customized image files 480, which typically use relatively more system memory. For example, the user may enter commands, such as ‘Generate Output Image with <R>’, into user information fields 212.

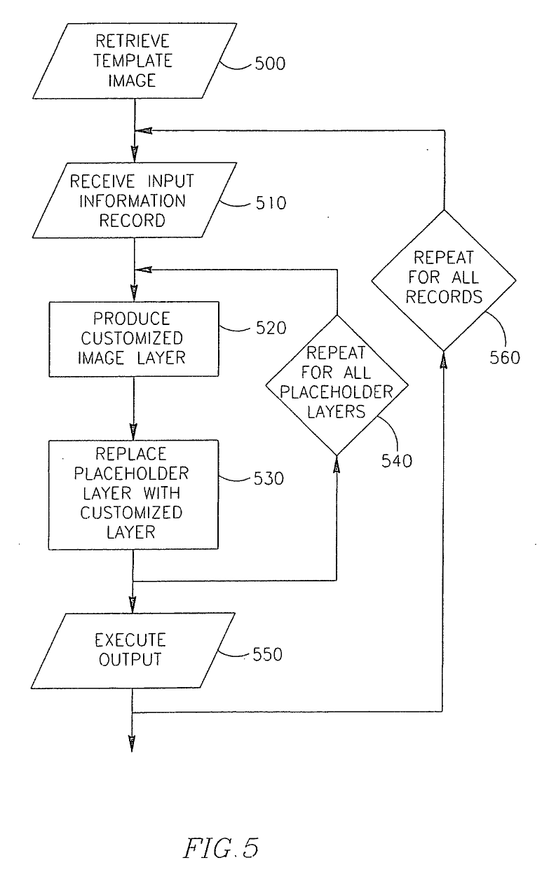

Reference is made to FIG. 5, which is a flowchart of a method according to one embodiment of the present invention.

In operation 500, for an individual information record, the graphic software module may retrieve or access a template image In some embodiments, the template image may be a multilayered image. Further, in some embodiments, the template image may have a plurality of placeholder layers. For example, there may be a template ‘Name’ layer corresponding to name information records, <R₁>, a template ‘State of Residence’ layer, corresponding to state of residence information records, <R₂>, etc. In some embodiments, when the individual information record corresponds to a specific category of information, the graphic software module may access the corresponding template layer, for example, the template layer that corresponds to the same category of information. The template layers may be designed or selected by the user according to the capabilities of the graphics software module or other supporting programs. In some embodiments, the user input information of operation 500 may be used to create the template layer. In some embodiment of the invention (not shown in FIG. 5), the module may use a logic rule to derive image data from the input information record.

In operation 510, the graphic software module may receive one or more input information record(s), for example, entered into a user interface on a computer, or taken from a data file, or produced by a logic module, or streamed serially, etc. The user input information, for example, R=(Bob, NY; Jen, MA; Curly, CA; . . . ) may define a plurality of information records or a stream of information records produced serially. Each information record may include one of more data fields. Alternatively, records that correspond to the same category of information may be grouped together in sets of information records. For example, sets of information records may include <R₁> and <R₂>, wherein each <R₁>=<Bob>, <Jen>, <Curly>, . . . corresponds to a set of name information records and <R₂>=<NY>, <MA>, <CA>, . . . , corresponds to a set of state of residence information records.

In operation 520, the graphic software module may produce a customized image layer, for example, by integrating information taken or derived from the individual information record into the corresponding template layer accessed in operation 510. For example, the graphic software module may integrate individual name information record, R₁=Bob, into the template Name Layer. Thus, graphic software module may individually create a customized image layer based on the individual information record. In one embodiment, the graphic software module may execute a series of commands, for example, the Generate Instance, to integrate the individual information record to create the customized image layer for the customer. The graphic software module may individually process the customized layer based oil the distinct information record. For example, Generate Instance may include a processing step to set the color of the integrated text “Curly” to blue for information record <Curly, Male> and to red for information record <Curly, Female>. It will be understood that in producing the customized image layer, the software module may access external information, for example, an image file to be inserted into the customized image layer.

In operation 530, the graphic software module may replace one of the place holder layers in the template image with the customized image layer created in operation 520 to create a customized image file based on the information record.

In operation 540, the graphic software module may loop operations 520 and 530 for all placeholder image layers in the template.

In operation 550 an output device or module may execute output operations, for example, print, save, display, email, convert to a single-layer format, etc. on the customized image file. In some embodiments, the user may select desired output operations. The customized image files may be outputted as multilayer or single layered image files. The output image files may be saved, viewed, used or further manipulated according to embodiments of the present invention, or by conventional methods. In one embodiment, the selected output operations can be defined by data in <R>. For example the output format can be decided based on some data field or a logical operation thereon.

In operation 560, operations 510 to 550 may be repeated for each of the plurality of individual information records. Modifications are possible for efficiency purposes. For example, for individual information records that correspond to different customers having similar information, the graphic software module may invoke the Generate Instance only once and use the output for both records. For examples, for customers Bob Smith and Bob Jones, the graphic software module may create one layer displaying the name Bob only once and use it for both records.

These operations may repeat until a customized image file is created using every one of the plurality of distinct information records corresponding to user input information or the operations are otherwise interrupted. Thus a plurality of customized image files may be created, each based on distinct information records corresponding to each individual input record.

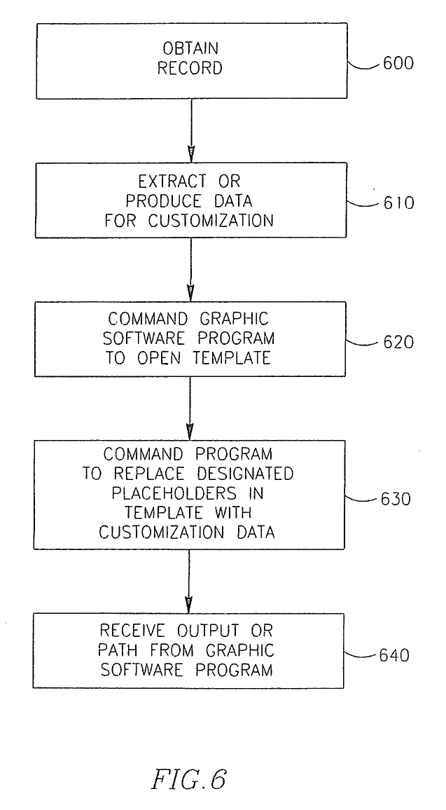

Some embodiments of the invention may take the form of a stand-alone or semi-integrated application or module in communication with another graphic software program that may execute some or all of the actual graphic processes discussed. FIG. 6 shows a basic flowchart of an embodiment of the invention operating as a stand-alone module interacting with a commercially available graphic software program such as Adobe Photoshop.

In step 600, the module may obtain or retrieve a record. This record may, for example, be retrieved from an information set stored in a database, or it may, for example, be produced by another application and provided as part of a stream of records.

In step 610, the module may extract or produce data for customization. In some applications, the data may simply be extracted from the record, for example, a character string name, which is a field in the record. In other applications, the module may conditionally retrieve data, for example, a prestored image or text, based on a condition of information in the record, for example, a first image if the record is for a boy, and a second image if the record is for a girl. Many logical operations may be performed on the record to produce the customization data. These logical operations may be stored in a rules file and accessed by the module.

In step 620, the module may command the graphic software program to open a template file. The template file may be sent from the module to the program, or only a pointer or file name of the template may be sent to the program. In some embodiments, there may be only one template associated with the application, or in other embodiments, the template file that the module commands the program to open may be selected by the module based on a logical operation performed based on the information in the record.

In step 630, the module may command the program to replace one or more designated placeholders with the customization data. The module may command the program to replace all or part of a placeholder file with customization data. For example, the module may command the program to replace a text string “<NAME>” in a placeholder layer in the template file with a particular text string “CURLY” extracted from the record in step 610. In another example, an entire placeholder layer may be replaced by an image selected in step 610 and provided to the program in step 630. The program may then perform the required substitution.

It will be noted that before step 630, the module may command the program to perform one or more pre-processing steps on the template file, as previously discussed above. The pre-processing may be selected based on logic rules and the record.

It will be noted that after step 630, the module may command the program to perform one or more post-processing steps on the template file, as previously discussed above. The post-processing may be selected based on logic rules and the record.

In step 640, the module may receive the output from the program. The output may take the form of the customized template image file, or it may be a path to the output file, or any other output. In some embodiments, additionally or alternatively to step 640, the module may command the program to print the customized file after completion. In another step, the module may command the program to close the template, save the customized image, or other suitable closing steps.

It will be appreciated that any or all of the features discussed above may be included additionally or alternatively in the embodiment shown in FIG. 6. For example, the process may repeat for so long as there are records to be processed.

It will be appreciated by persons skilled in the art that the present invention is not limited to what has been particularly shown and described hereinabove. Rather the scope of the present invention is defined only by the claims, which follow:

1. A method comprising:
providing a template image file including at least one placeholder layer;
receiving a plurality of input records;
modifying at least one of said placeholder layers in said template image file based on a logic operation performed on the input record; and
repeating said modifying step for each of said plurality of input records.

2. The method of claim 1, further comprising providing a rules file including said logic operation to be performed on the input record.

3. The method of claim 1, wherein modifying the placeholder layer comprises replacing a portion of said placeholder layer with text based on the input record.

4. The method of claim 1, wherein modifying the placeholder layer comprises replacing said placeholder layer with a customized image layer created based on said logic operation performed on the input record.

5. The method of claim 1, wherein modifying the placeholder layer comprises replacing said placeholder layer with a customized image layer selected based on said logic operation performed on the input record.

6. The method of claim 1, further comprising performing an output operation on said modified template image file.

7. The method of claim 6, wherein said output operation is selected from a plurality of possible output operations based on an output logic operation performed on the input record.

8. The method of claim 1, wherein said template image file includes a plurality of placeholder layers, and said step of modifying comprises modifying each of said plurality of placeholder layers in said template image file based on data in the input record.

9. The method of claim 1, wherein said modifying comprises integrating data from the input record into said placeholder layer.

10. The method of claim 1, further comprising processing the template image based on data from said input record file prior to said modifying step.

11. The method of claim 10, wherein said processing step is based on a pre-processing logic operation performed on said input record.

12. The method of claim 1, further comprising processing the template image file based on data from said input record after said modifying step.

13. The method of claim 12, wherein said processing step is based on a post-processing logic operation performed on said input record.

14. The method of claim 1, wherein receiving said plurality of input records comprises retrieving said data records from a database.

15. The method of claim 1, wherein said step of modifying said placeholder layer in said template image file comprises commanding a graphic software program to perform the modification.

16. The method of claim 15, further comprising commanding said graphic software program to perform an output operation on said modified template image file.

17. The method of claim 1, wherein providing said template image file comprises selecting a template image file from a plurality of template image files based on a template logic operation performed on said input record.

18. A system comprising:
a template image file including at least one placeholder layer;
a plurality of input records; and
a graphic customization module to
perform a logic operation on each said input record,
modify said placeholder layer in said template image file based on an output of said logic operation, and
repeat said performing and modifying operations for each of said plurality of input records.

19. The system of claim 18, further comprising a rules file including said logic operation to be performed on said input record.

20. The system of claim 18, wherein said graphic customization module is to modify said placeholder layer by replacing said placeholder layer with a customized image layer created based on data in the input record.

21. The system of claim 18, wherein said graphic customization module is to modify said placeholder layer by replacing a portion of said placeholder layer with text based on the input record.

22. The system of claim 18, wherein said graphic customization module is to modify said placeholder layer by replacing said placeholder layer with a customized image layer selected based on an outcome of said logical operation performed on said input record.

23. The system of claim 18, wherein said graphic customization module is further to perform an output operation on said modified template image file.

24. The system of claim 23, wherein said graphic customization module is further to select said output operation from a plurality of possible output operations based on an output logic operation performed on said input record.

25. The system of claim 18, wherein said template image file includes a plurality of placeholder layers, and said graphic customization module is modify said placeholder layer by modifying each of said plurality of placeholder layers in said template image file based on the input record.

26. The system of claim 18, wherein said graphic customization module is modify said placeholder layer by integrating data from the input record into said placeholder layer.

27. The system of claim 18, wherein said graphic customization module is to process said template image file based on data from said input record prior to modifying said placeholder layer in said template image file.

28. The system of claim 27, wherein said graphic customization module is to process said template image file prior to modifying a placeholder layer therein based on a pre-processing logic operation performed on said input record.

29. The system of claim 18, wherein said graphic customization module is process said template image file based on data from said input record after modifying said placeholder layer in said template image file.

30. The system of claim 29, wherein said graphic customization module is to process said template image file after modifying a placeholder layer therein based on a post-processing logic operation performed on said input record.

31. The system of claim 18, wherein said graphic customization module is further to retrieve said data records from a database.

32. The system of claim 18, wherein said graphic customization module is to modify said placeholder layer in said template image file by commanding a graphic software program to perform the modification.

33. The system of claim 32, wherein said graphic customization module is further to command said graphic software program to perform an output operation on said modified template image file.

34. The system of claim 32, wherein said graphic customization module is to command said graphic software program to access said template image file.

35. The system of claim 18, wherein said graphic customization module is to select said template image file from a plurality of template image files based on a template logic operation performed on said input record.
